(19) United States
(12) Patent Application Publication
(10) Pub. No.: US 2010/0071345 A1
(43) Pub. Date: Mar. 25, 2010

(54) Thrust Engine

(76) Inventors: Guy Silver, Cupertino, CA (US); Juinerong Wa, Cupertino, CA (US)

Correspondence Address: Haynes and Boone, LLP;IP Section, 2323 Victory Avenue, SUITE 700, Dallas, TX, 75219, US

(21) Appl. No.: 12/235,477

(22) Filed: Sep. 22, 2008

(51) Int. Cl. F02K 3/00

(52) U.S. Cl. 60/269

(57) ABSTRACT

According to the present invention, a blade with lift-to-drag ratio greater than one can generate a lift force greater than the drag force on the blade when a fluid flows across the blade. The blade can be positioned within an enclosed engine to produce a force greater than the force required to move the fluid across the blade, thereby creating a thrust for the enclosed engine. The direction and the magnitude of the thrust may be controlled by controlling the direction of fluid flow. According to the present invention, fluid flowing inside a thrust engine may be gaseous or liquid. A thrust engine of the present invention uses one or more wings in a configurable environment to create a directional force. Thrust engines according to the present invention can be configured by varying fluid parameters, such as density or velocity, the wing parameters (such as wing geometry, lift coefficient or plane surface area of the wing), the number and the locations of wings, how the fluid receives energy, fluid motion, fixed or movable wings and the fluid path.

### BACKGROUND OF THE INVENTION

1. Field of the Invention

The present invention relates to the design and use for thrust engines that apply principles of aerodynamic of one or more objects (e.g., wing, airfoil or blade) in contact with a moving fluid (i.e., liquid or gas) inside a chamber or a housing.

2. Discussion of the Related Art

An aircraft thrust engine provides a high-velocity airflow in a pre-determined direction to generate force. Examples of thrust engines include gas turbine engines and gas turboprop engines. Thrust power can be created mechanically by driving the rotation of a propeller or a set of blades at high speed. All thrust engines today create high velocity airflows requiring safety measures to prevent harm to people and objects in their surrounding during their operations.

There are many wing and airfoil designs available from many sources including on-line UIUC airfoil database, NACA and many more modern airfoils. During the 1920's and 1930's, NACA designed and tested a variety of wing designs and published characterization results for the wing designs in a systematic set of graphs. These results are still used today in designing wings for many applications. The graphs give lift and drag coefficients for airfoils (shows the cross section of the wing) based upon the airfoils angle of attack in the fluid flow. Using these coefficients, lift and drag can be calculated using the following equations:

$$\begin{matrix}Lift = \frac{1}{2} {C}_{l} ρ {V}^{2} A & 1 ) \\ Drag = \frac{1}{2} {C}_{d} ρ {V}^{2} A & 2 )\end{matrix}$$

where
Cₗ is the lift coefficient, C_{d} is the drag coefficient, ρ is the density of the fluid, V is the velocity of the wing relative to the fluid, and A is the surface area of the airfoil.

The ratio of the lift to the drag (L/D ratio) is used as a measure for the aerodynamic quality and efficiency of lift creation by the airfoil or blade design. The lift generated by a wing at a given velocity and angle of attack can be 1-2 orders of magnitude greater than the drag. Therefore, a significantly smaller force can be applied to propel the wing through the air in order to obtain a specified lift. Lift to drag ratios for practical aircraft vary from about 4:1 up to 50:1 or more. There are many methods for determining the force of lift.

A heat engine refers to a device that converts heat energy into mechanical energy. A heat engine operates by converting the fluid energy which flows between two sections of the heat engine having different temperatures into mechanical power. The higher the temperature difference between the two sections, the higher the efficiency of the heat engine. The temperature difference between two areas inside the heat engine is used to keep fluid circulation within the engine.

An impeller is a rotor inside a tube or conduit which increases the pressure and flow of a fluid. An impeller is typically a rotating component of a centrifugal pump which transfers energy from a motor that drives the pump to the fluid being pumped. An impeller accelerates the fluid outwards from the center of rotation. The velocity achieved by the impeller transfers into pressure when the outward movement of the fluid is confined by the pump casing. Impellers are usually short cylinders with an open inlet (called an eye) to accept incoming fluid, and vanes to push the fluid radially.

A propeller is essentially a type of fan which transmits power by converting rotational motion into thrust for propelling a vehicle (e.g., an aircraft, a ship or a submarine) through a mass medium, such as water or air. A propeller operates by rotating two or more twisted blades about a central shaft, in a manner analogous to rotating a screw through a solid. The blades of a propeller act as rotating wings¹, and produce a force by generating a difference in pressure between the forward and rear surfaces of the airfoil-shaped blades and by accelerating a mass of air rearward. ¹The blades of a propeller are in fact wings or airfoils.

To create a thrust to push through the fluid (i.e., overcoming the drag associated with lift) requires energy. Different objects capable of flight vary in the efficiency of their engines and how well lift translates into forward thrust.

### SUMMARY

According to one embodiment of the present invention, a thrust engine uses one or more wings in a configurable environment to create a directional force. The thrust engine can be configured by varying fluid parameters, such as density or velocity, the wing parameters (such as wing geometry, lift coefficient or plane surface area of the wing), the number and the locations of wings, how the fluid receives energy, fluid motion, fixed or movable wings and the fluid path.

A thrust engine of the present invention may be used to propel an automobile or another vehicle. It can also be incorporated, for example, in any application in which a source of heat energy is provided.

The present invention is better understood upon consideration of the detailed description below in conjunction with the drawings.

### BRIEF DESCRIPTION OF THE DRAWINGS

FIG. 1 shows a cross-sectional view of thrust engine 100, having two fixed wings, according to one embodiment of the present invention.

FIG. 2 shows a transverse sectional view of thrust engine 100 along line A-A′ of FIG. 1.

FIG. 3 shows thrust engine 300, which is an alternative embodiment of the present invention in which housing 103 is provided fluid structure 107, located in center portion 104d, with fluid flowing radially across wings 101 and 102.

FIG. 4a shows an adjustable annular wing 400 suitable for use in thrust engine 100 and thrust engine 300.

FIG. 4b shows the control elements for adjusting an angle of attack in annular wing 400.

FIG. 4c shows adjustable air-foil blade 450.

FIG. 5 shows a cross-sectional view of thrust engine 500 with spiral blades, according to one embodiment of the present invention.

FIG. 6a shows a transverse sectional view of thrust engine 500 along line A-A′ of FIG. 5.

FIG. 6b shows an adjustable blade of thrust engine 500 in FIG. 5.

FIG. 7a shows thrust engine 700, according to another embodiment of the present invention.

FIG. 7b shows thrust engine 750 according to another embodiment of the present invention.

FIG. 8 shows an annular tube 800 with blades rotating through the fluid inside housing 801, according to one embodiment of the present invention.

### DETAILED DESCRIPTION OF THE PREFERRED EMBODIMENTS

When a fluid flows pass an object, the difference in resulting velocities of the fluid on opposite surfaces of the object creates a lift force on the body of the object. The lift force may be harvested for providing an output of a thrust engine. The vector sum of the lift forces inside the thrust engine provides the thrust engine's output.

A thrust engine refers to a device that converts fluid energy or heat energy into a force. A thrust engine, according to the present invention, operates by converting energy loss from drag forces that is due to fluid flowing across an aerodynamic blade into a lift force on the blade to create a thrust for the thrust engine. An aerodynamic blade is characterized by a lift-to-drag ratio (L/D ratio). The lift-to-drag ratio determines the thrust created by the aerodynamic blade. According to the present invention, a blade with lift-to-drag ratio greater than one can generate a lift force greater than the drag force on the blade when a fluid flows across the blade. The blade can be positioned within an enclosed engine to produce a force greater than the force required to move the fluid across the blade, thereby creating a thrust for the enclosed engine. The direction and the magnitude of the thrust may be controlled by controlling the direction of fluid flow. According to the present invention, fluid flowing inside a thrust engine may be gaseous or liquid.

A thrust engine of the present invention uses one or more wings in a configurable environment to create a directional force. Thrust engines according to the present invention can be configured by varying fluid parameters, such as density or velocity, the wing parameters (such as wing geometry, lift coefficient or plane surface area of the wing), the number and the locations of wings, how the fluid receives energy, fluid motion, fixed or movable wings and the fluid path.

A thrust engine of the present invention may be used to propel any objection, such as an automobile or another vehicle, and be incorporated into any application requiring an engine. In some embodiments, a source of heat energy may be provided to power the thrust engine.

To simplify this detailed description and the drawings, references that are made to an airfoil (rather than to a blade or specific wing geometry) are understood to be equally applicable to other structures with aerodynamic effects, such as wings, aerodynamic blades, and airfoils. For this purpose, a wing is a surface used to produce lift for an object through the air or another gaseous medium. The wing typically has a shape of an airfoil.

When a solid object moves through a fluid, lift is generated. Equivalently, a lift is generated when an object has a fluid flow moving past it. The present invention provides thrust engines that operate under a heat differential or a pressure differential to convert the heat energy or the fluid kinetic energy into thrust. The thrust engine of the present invention uses a closed cycle to move objects on land, water, under water, in the air or in space.

Pumps or heat may be used to put fluid into motion or to increase fluid circulation inside an engine. A thrust engine of the present invention with fluid energy provided by heat may operate with any source of heat energy, including solar, electrical, fossil or other fuels. A thrust engine of the present invention operates when a sufficient temperature difference is created between two portions of the engine. The thrust created by a thrust engine of the present invention provides a directional force based on the orientation and the internal configuration of the engine (e.g., as blade parameters and fluid parameters).

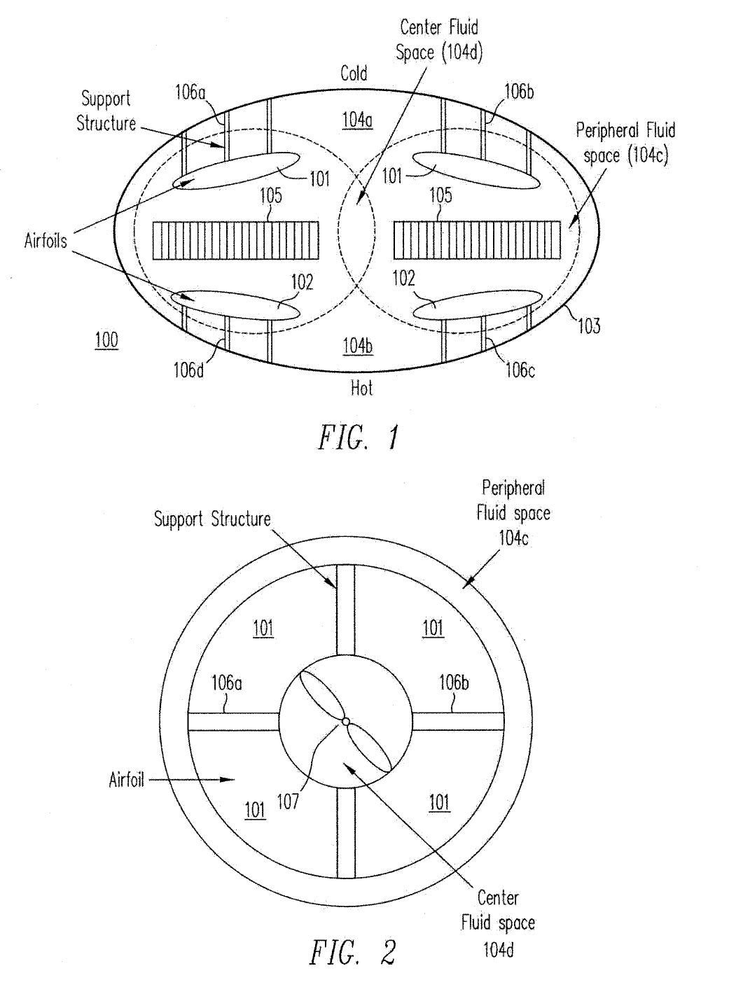

FIG. 1 shows thrust engine 100, according to one embodiment of the present invention. FIG. 2 shows a transverse sectional view of thrust engine 100 along line A-A′ of FIG. 1. As shown in FIG. 1, wings 101 and 102 are suspended inside housing 103 which is divided by an annular partition 105 into upper portion 104a and lower portion 104b. (Note the designations “upper” and “lower” are merely provided to facilitate description in this detailed description; housing 103 may be oriented in any direction.) Annular partition 105 may be a wing or an object with an aerodynamic effect. Annular partition 105 provides partition and creates lift in a preferred direction.

The fluid flow of thrust engine 100 may be self-starting by gravity and rising hot fluid. An intake fluid valve may be used to bring in pressurized fluid to start the engine and control pressure inside the engine. The fluid circulates between upper portion 104a and lower portion 104b through peripheral portion 104c and central portion 104d. Central portion 104d may be a funnel shape space to increase fluid flow. Wings 101 and 102 are fixed in their positions relative to housing 103 by support structures 106a 106b, 106c and 106d. Support structures 106a 106b, 106c and 106d may be used to transfer heat to or away from the engine. Support structures may also have an aerodynamic effect on lift creation.

As shown in FIG. 2, wing 101 is annular when viewed from the top (or bottom) to allow fluid flow between peripheral region 104c and central portion 104d. Wing 102 may be provided different shape and size as wing 101.

According to one embodiment, upper portion 104a is maintained at a lower temperature relative to the temperature at lower portion 104b, thereby providing a circulation of the fluid. The fluid flows radially outwards in lower portion 104b, enters upper portion 104a through peripheral fluid space 104c, flows radially inwards toward center fluid space 104d and returns to lower portion 104b through center fluid space 104d. Multiple heating areas and cooling areas may be located inside housing 103 to optimize working fluid flow.

The direction and velocity of fluid flow over (and underneath) each wing is determined by the geometry of wing 101. As discussed above, the lift and drag created by wings 101 and 102 as fluid flow over and underneath provide a thrust. The magnitude of the thrust or thrust force depends on the positions and the dimensions of wings 101 and 102 and their respective lift coefficients and drag coefficients. In one embodiment, heating or cooling elements may be embedded inside wings 101 and 102 to heat or cool the fluid and to create the temperature difference between upper portion 104a and lower portion 104b. In one embodiment, a heating element or a cooling element or both may be embedded within wings 101 and 102 to change the velocity of fluid flow around wings 101 and 102. Heating sources are placed where high pressure is needed and cooling sources are placed where low pressure is needed.

In one embodiment, metal is a preferred material for providing wings 101 and 102 and housing 103 to achieve efficient heating and cooling. Generally, a wing with a higher lift-to-drag ratio is deemed more efficient—i.e., creates a greater thrust for a given amount of input power—for a thrust engine of the present invention. Other factors also affect the selection of the lift-to-drag ratio (e.g., power dissipation).

The working fluid inside housing 103 may be a gas or a liquid. A gaseous working fluid may be pressurized, if desired. A gaseous working fluid has the advantage that a wider range of fluid densities result from the same temperature difference between portions 104a and 104b. A higher density pressurized gas may provide a greater thrust in a thrust engine of the present invention. A pressurized gaseous working fluid also prevents fluid separation issues that may occur at the wings. In accordance of the present invention, because a gas density can be changed by adjusting the pressure, the thrust produced maybe controlled by changing the working fluid pressure during operation of the thrust engine.

Wings inside a thrust engine may be arranged in parallel or in layers to enhance the thrust in a preferred direction. A thrust engine with at least two fluids with different fluid parameters (e.g., fluid density and velocity) may be configured. In one embodiment, a thrust engine having spiral passages or a spiral shape housing can have fluid flow rotating between upper portion 104a and lower portion 104b through peripheral fluid space 104c and center fluid space 104d. In another embodiment, the fluid flows radially outwards in upper portion 104a, enters lower portion 104b through peripheral fluid space 104c, flows radially inwards toward center fluid space 104d and returns to upper portion 104a through center fluid space 104d. According to one embodiment, upper portion 104a is maintained at a higher temperature relative to the temperature at lower portion 104b. A one-way valve may be provided in the center fluid space 104d to allow fluid flow between upper portion 104a and lower portion 104b.

A mechanism to direct the fluid flow may be provided. Once fluid flow is started, the temperature gradient between lower portion 104b and upper portion 104a can maintain the fluid flow direction. The fluid flow in a preferred direction may be initiated using a propeller, which may be powered externally or powered from a mechanism provided in separator or partition 105. Alternatively, a valve system may be provided in the walls of housing 103 to provide a flow of air from the exterior through housing 103 and discharged to the exterior again.

During operation, the temperature difference between upper and lower portions 104a and 104b determines the speed of fluid flow. The thrust force is proportional to the square of the speed of the fluid flow across the wings. In the direction of lift force, the thrust force is equal to the wing drag times the lift-to-drag ratio. The energy lost from the fluid as the fluid flows across the wings are attributed to the drag and the frictional forces over the surface of the wings.

The temperature difference may be maintained using center fluid space 104d and peripheral fluid space 104c to provide heating and cooling, instead of upper portion 104a and lower portion 104b. In this configuration, the thrust engine may or may not be self-started depending on thrust engine's orientation. In one embodiment, the temperature difference is maintained using center portion 104d and peripheral portion 104c. Also, more than two portions within the thrust engine housing may be used to heat and cool the working fluid especially for larger thrust engines with long fluid paths. In one embodiment, three or more portions within the thrust engine housing are used to heat and cool the working fluid.

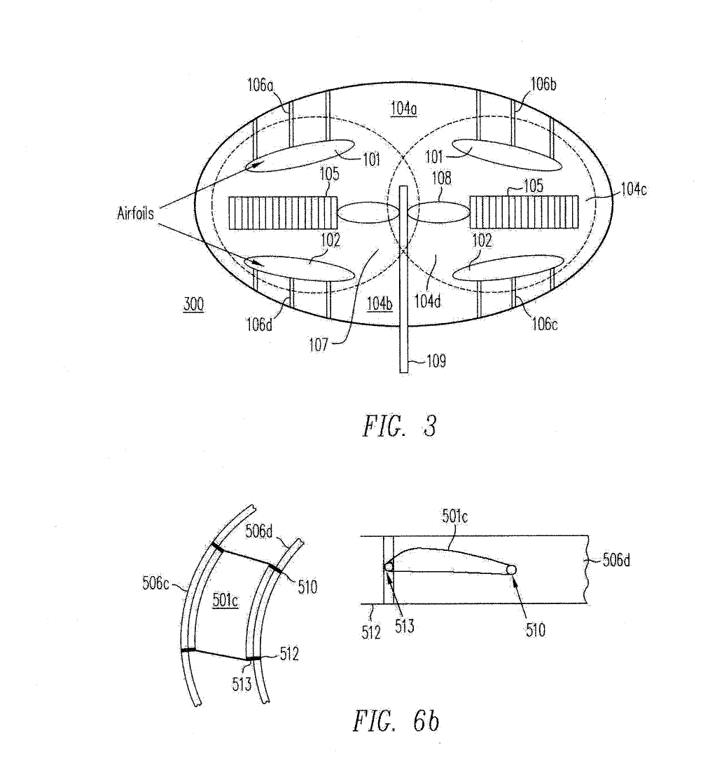

FIG. 3 shows thrust engine 300, which is an alternative embodiment of the present invention in which housing 103 is provided fluid structure 107, which has a set of blades 108 and an axle 109, and which is located in center portion 104d, with the fluid flowing radially across wings 101 and 102. Fluid structure 107 uses mechanical forces to push the fluid into circulation. Fluid structure 107 may function as a pump, an impeller, a propeller, a compressor, a fan or a blower depending on the configuration of blade set 108 and the application of the engine. In one embodiment, Fluid structure 107 may have adjustable blades or blade configurations such that blade set 108 provides energy for fluid to flow or contribute to the lift force. The thrust force achieved in thrust engine 300 can be controlled by adjusting the amount of fluid pumped by fluid structure 107. In one embodiment, blade set 108 may have airfoil-shaped sections producing a resultant aerodynamic force that may be resolved into a force pointing along the axis of the blade rotation. Fluid structure 107 may function as a propeller. Annular partition 105 may be part of the blade set 108 of fluid structure 107 allowing annular partition to rotate with axle 109.

As in thrust engine 100, thrust force achieved in thrust engine 300 depends upon the positions and the dimensions of wings 101 and 102, the dimensions and shape of housing 103 and the material selected for wings 101 and 102 and housing 103. Generally, any material that can handle the resulting lift force may be used for wings 101 and 102, including any metal, plastics or composite materials. Housing 103 may be made out of any material that can handle fluid pressure and can dissipate the heat generated from the frictional forces of the fluid flow over wings 101 and 102.

The working fluid for thrust engine 300 may be gaseous or liquid. When using a gas as the working fluid, having the gas pressurized may increase the thrust force. Working fluid having a smaller kinematic viscosity (viscosity/density) may increase the thrust engine efficiency. Unlike thrust engine 100, however, thrust engine 300 starts up by the fluid flow created by fluid structure 107. Fluid velocity increases as long as fluid pressure at fluid structure 107 is greater than the pressure drop due to the drag and frictional forces along the fluid flow paths. Fluid structure 107 may be locate in upper portion 104a, lower 104b or peripheral fluid space 104c, or wherever the fluid structure 107 can create a desirable fluid flow within thrust engine 300. In one embodiment, a thrust engine powered by a heat difference and a compressor (or propeller) may be implemented. Thrust engine 100 may use a compressor (propeller) type of fluid structure located in center fluid space 104d to compress fluid and increase fluid velocity fluid.

Fluid structure 107 may be provided with more than one set of blades to drive fluid to do work on wings. Fluid structure 107 may have mechanisms allowing blades to fold around axle 109 or to align to the interior wall of housing 103, when no mechanical input power is provided to drive the fluid structure 107. In one embodiment, the blades inside fluid structure 107 may function as diffuser to convert rotational fluid to a high pressure fluid without a rotation, such that fluid structure 107 need not be continuously powered by an external mechanical power source. Blades in fluid structure 107 may be powered by a spiral spring. Wings creating lift can form fluid passages.

Wings may be adjustable to control the lift generated by the wing. Adjustment may be implemented through controlling the angle of attack or by tilting the wings. In some embodiments, the “angle of attack” at each wing may be controlled to achieve the desired thrust force to be experienced at that wing. Unlike a fixed wing, one type of adjustable wings can change the angle of attack to the working fluid flow direction during operation. As such an adjustable wing changes its angle of attack, the surface area of the wing may also change. For such a wing, multiple overlapping sections may be used to maintain a continuous wing surface. In one embodiment, the operating angle of attack of the blade can be adjusted to get the best economic advantage of the lift created.

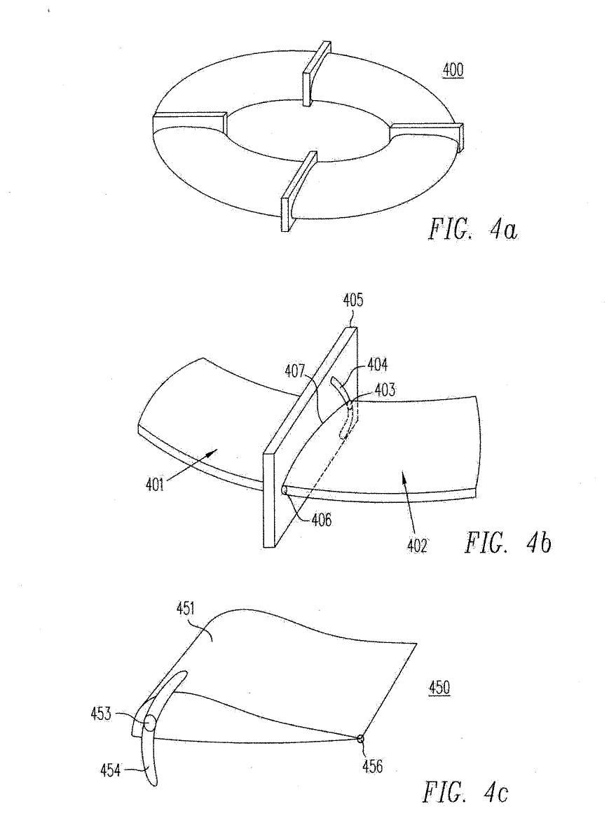

FIG. 4a shows an adjustable annular wing 400. FIG. 4b shows a control mechanism for changing an operating angle of attack in annular wing 400. As shown in FIG. 4b, sections 401 and 402 are coupled to blade support 405 by adjust rod 403 and pivot rod 406. Movement of adjust rod 403 within rod guide 404 can be carried out using hydraulics or another method know in the art. The movement of adjust rod 403 controls the angle of attack of blade sections 401 and 402 by pivoting blade sections 401 and 402 on pivot rod 406. Rod guide 404 is curved to match the path of the of blade sections 401 and 402 as it pivots around pivot rod 406. Adjust rod 403 may simultaneously move blade sections 401 and 402 or independently move blade sections 401 and 402, as desired.

FIG. 4c shows an adjustable aerodynamic blade 450. In FIG. 4c, section 451 is coupled to blade support (not shown) by adjust rod 453 and pivot rod 456. Movement of adjust rod 453 within rod guide 454 may be carried out using hydraulics or another method known in the art. The movement of adjust rod 453 controls the angle of attack of blade section 451 by pivoting blade section 451 on pivot rod 456. Rod guide 454 is curved to match path of the of blade section 451 as it pivots around pivot rod 456.

As the angle of attack determines the lift force and the drag force experienced at each wing, the total thrust force created by the thrust engine of the present invention may be adjusted by adjusting the angle of attack at each wing. Such an approach has the advantages: (a) the lift force can be changed rapidly and accurately; (b) the lift force can be adjustable to create a forward and reverse direction; and (c) a large number of wings may be provided by splitting wings 101 and 102 into many sections, with each section provided a different angle of attack, thereby allowing control of both the direction of the force as well as the magnitude of the thrust force thus created. Since the drag force vary with the angle of attack, the fluid pressure loss during the engine cycle also changes. Therefore, the heat difference, the propeller speed or the fluid structure may be adjusted to compensate for these fluid pressure changes. An engine control device may be provided to adjust both the angle of attack and the fluid flow speed. Sensors which measure the fluid flow speed at each wing may also be provided.

In some embodiments, more than two wings may be provided. Having more than two wings may provide a more compact design to meet the desired thrust requirements. Each wing may be an adjustable wing or a fixed wing, depending on the system thrust requirements. In one embodiment, wings 101 and 102 are movable in their positions relative to housing 103 by support structures 106a, 106b, 106c and 106d. According to the present invention, wings 101 and 102 are adjustable in their angles relative to fluid flow in housing 103. To create lift, wings 101 and 102 may be placed anywhere inside the housing of the thrust engine. Fluid velocity may be changed by controlling a fluid volume flow rate at a specific area. By varying the amount of fluid flow around wings 101 and 102, appreciable lift may be created. Heating or cooling may also be used to change fluid velocity or fluid density.

Thrust engine 300 can support both a circular and a rotational fluid flow in accordance of the present invention. Blade set 108 of fluid structure 107 may be designed to rotate fluid to create rotational fluid flows within housing 103. Blade set 108 may be placed axial along radial directions at locations where the rotational fluid flow is desired. Wings 101 and 102 can be configured to create lift from the rotating fluid that flows across them. By rotating the fluid, the fluid path across wings 101 and 102 can be increased, thus increasing the lift force created on wings 101 and 102. In one embodiment, thrust engine 300 has fluid structure 107 configured to rotate fluid outwards in lower portion 104b. The fluid enters upper portion 104a rotationally through peripheral fluid space 104c, flows rotationally inwards toward center fluid space 104d and returns to lower portion 104b rotationally through center fluid space 104d. In one embodiment, thrust engine 300 has fluid structure 107 configured to rotate fluid outward outwards in upper portion 104a, enter lower portion 104b by rotating through peripheral fluid space 104c, flows rotationally inwards toward center fluid space 104d and returns to upper portion 104a rotationally through center fluid space 104d.

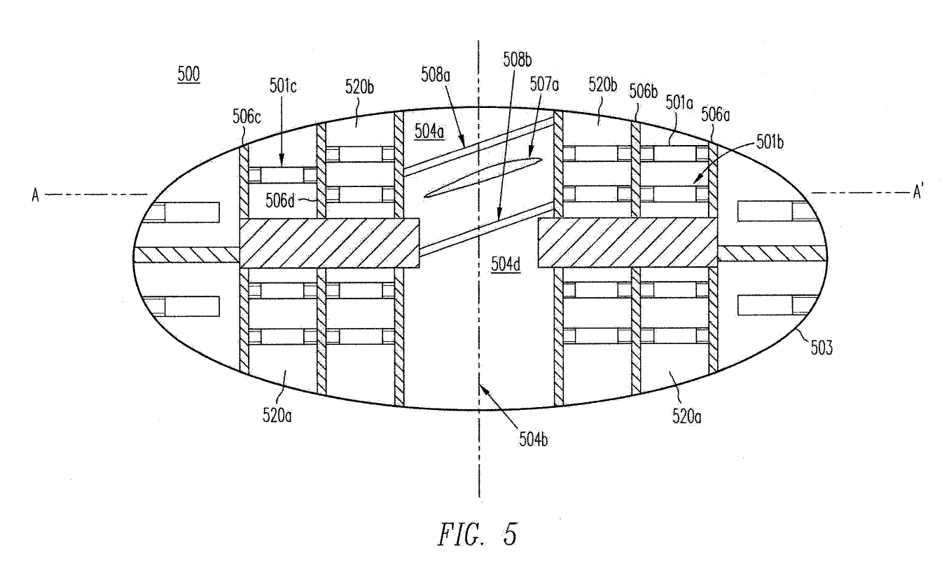

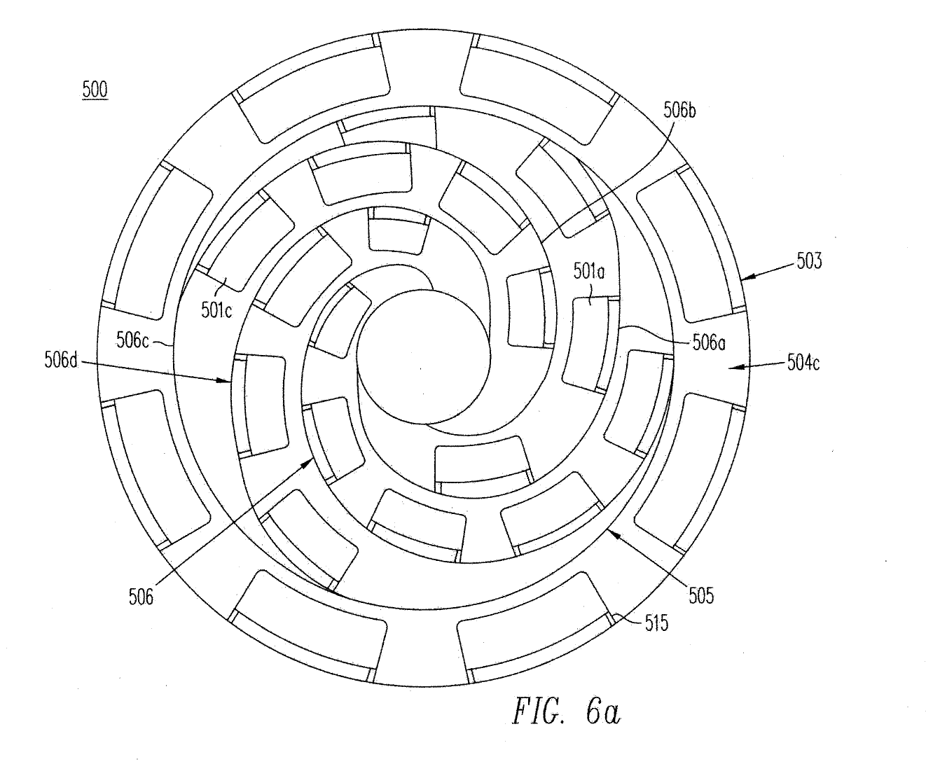

According to another embodiment, FIG. 5 shows thrust engine 500 having spiral walls in both upper portion 504a and lower portion 504b, which form spiral channels for the working fluid to flow. The resulting fluid rotates about an axis. The spiral walls may be attached to interior housing 503 and annular partition 505. Having spiral working fluid paths increases the working fluid path length, which can provide an increase of wings surface area in contact with the working fluid. Each spiral channel has a plurality of discontinuous wings used to create thrust. One such spiral channel can be seen between spiral wall 506a and spiral wall 506b, wing 501a and wing 501b. Wings within spiral channels may form multiple layers as illustrated by wings 501a and 501b or form a single layer.

FIG. 6a shows a top view of upper portion 504a of thrust engine 500 through line A-A′, showing the spiral channels and a single layer of wings within each channel. Having multiple layers of wings within a spiral channel can increase the thrust generated. Some factors in determining the number wing layers within a spiral channel are the channel height, wing thickness and working fluid flow velocity. Each wing may be attached to the spiral walls and can be a fixed wing or an adjustable wing. Support structures 515 connects wing to interior housing wall inside peripheral fluid space 504c.

The connection of spiral wings to spiral walls can be better seen from FIG. 6b which shows spiral wing 501c coupled to spiral walls 506c and 506d by adjust rod 513 and pivot rod 510. Adjust rod 513 moves within rod guide 512 driven by hydraulics or another method known in the art. The movement of adjust rod 513 controls an angle of attack of spiral wing 501c by pivoting blade 501c on pivot rod 510. Rod guide 512 is curved to match the path of spiral wing 501c as it pivots around pivot rod 510.

In FIG. 5, working fluid flow possesses vorticity (i.e., vortices are formed in the fluid flow). The working flow exerts a continuous force and imparts momentum on the spiral walls and wings. As shown in FIG. 5, since the working fluid circulation is a convective vertical circulation, the vorticity may be nearly horizontal. The working fluid flow from cold zone 520b in upper portion 104a to hot zone 520a in lower portion 104b is a rotating downdraft. (Here, “hot zone’ and “cold zone” merely means higher and lower temperature regions (relative to each other), respectively.) Similarly, the working fluid flow from hot zone 520a to cold zone 520b is a rotating updraft. The momentum of the working fluid is continuously maintained during the engine cycle. The working fluid continuously heats, expands, cools and contracts in the respective zones during each engine cycle. Therefore, a complete engine cycle and a complete working fluid path are provided within housing 503. During an engine cycle, the working fluid exerts force on the wings.

As discussed above, the working fluid has vorticity and has a continuous momentum, resulting from the heating and cooling of the working fluid, and the spiral walls direct the working fluid into a rotational motion. Wings may be designed to cause rotational motion in the fluid. Spiral walls and wings may be used as support structures coupled to housing 503 or providing heat transfer functions.

Therefore, under this environment, the longer the engine runs, the faster the working fluid circulates until the velocity of the working fluid at the end of a first cycle becomes the velocity of the working fluid at the beginning of a second cycle, and is increased throughout the second cycle. The working fluid velocity is increased by the kinetic energy, which is then converted by the heat engine into thrust work. The working fluid velocity increases during both the expansion phase and the contraction phase of an engine cycle.

The shape of the wings or spiral walls helps in rotating the working fluid. Wings inside thrust engine 500 can also be used to adjust the temperature of various portions of the engine—i.e., to vary the temperature of the hot zone 520a, or to vary the temperature of the cold zone 520b.

The rotational and radial outward flow of the working fluid in hot zone 520a, the upward movement into cold zone 520b, the rotational and radial inward flow of the working fluid in cold zone 520b, and the downward movement into hot zone 520a extends along the length of the downdraft. The speed of the rotation or ‘twisting’ increases as the effective column diameter diminishes. The cold working fluid is carried more effectively through the space in the form of a spinning downdraft. The high fluid velocities result from conservation of angular momentum. The engine design is based on moving the working fluid by continuously heating and cooling, and to use the wings (aerodynamic blades) to rotate the working fluid (i.e. maintaining the momentum in the working fluid).

Unlike thrust engines 100 and 300, by having the working fluid rotate, thrust engine 500 can produce thrust by having discontinuous wings placed in peripheral portion 504c. FIG. 5 shows peripheral wing 507a of peripheral wing set 507 within a peripheral channel formed by peripheral walls 508a and 508b that are attached to interior housing 503 and optionally attached to annular partition 505. These peripheral channels guide the working fluid between upper portion 504a and lower portion 504b. Using peripheral walls to form peripheral channels allows peripheral wings more flexibility in positioning their angles of attack on the working fluid. Peripheral channels may also be formed by the peripheral wings, thus increasing the number of wings that produce thrust. However the peripheral wings must have an angle of attack on the working fluid to maintain circulation of the working fluid between upper portion 504a and lower portion 504b. In one embodiment, thrust engine 500 uses peripheral wings to form peripheral channels for the working fluid to flow between upper portion 504a and lower portion 504b.

Thrust engine 500 may be powered by a temperature differential such as shown in thrust engine 100 or powered by a fluid structure (not shown) such as shown in thrust engine 300. When a fluid structure is used for a rotational fluid flow, any structure that maintains circulation of the working fluid can be used, including a pump using an axial or a radial rotating set of blades. When a fluid structure is used for a rotational fluid flow, a propeller set of blade that rotates in the opposite direction of the fluid and that uses the angular velocity difference between the fluid and the blades to create a lift force to maintain the rotational fluid flow cycle may be more efficient. In one embodiment, thrust engine 500 uses a fluid structure with a set of blades that uses the angular velocity difference between the fluid and the set of blades to keep fluid circulation. During operation, the fluid angular velocity at the set of blades may be sufficiently high such that the set of blades does not need to rotate (i.e. no input power) to keep fluid cycling.

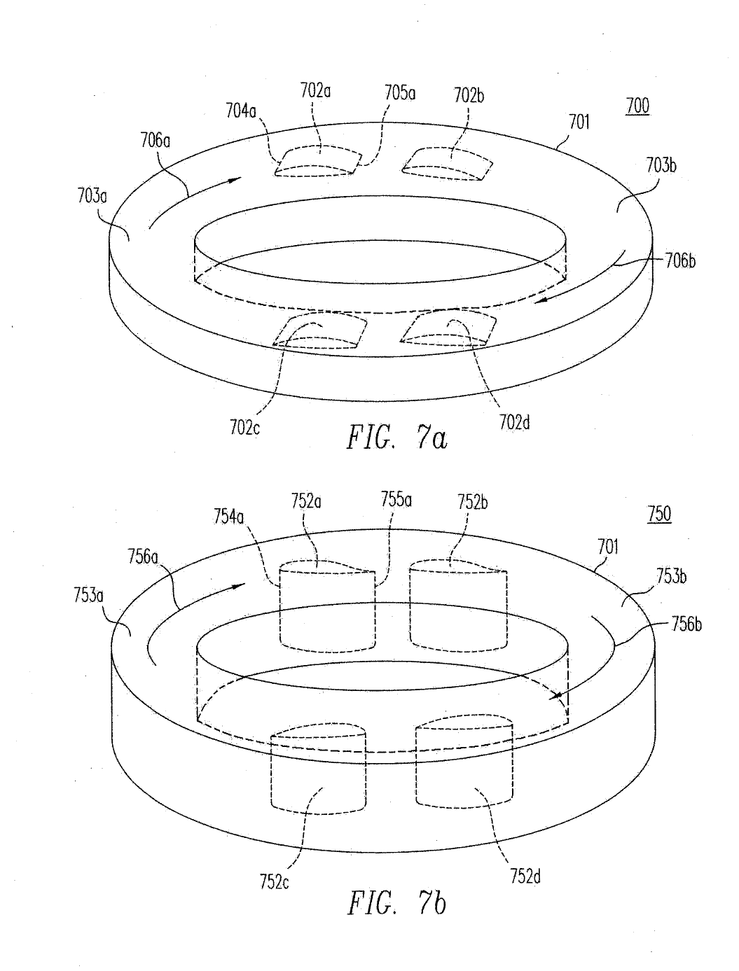

Thrust engine 700 and thrust engine 750 of FIGS. 7a and 7b, respectively, have different directional thrust resulted from orienting wing set 702 in horizontal and vertical positions. In one embodiment, thrust engine 700 includes circular tube shaped housing 701 enclosing a working fluid and wing set 702, having wings 702a, 702b, 702c and 702d. The working fluid circulates through the interior of housing 701 in the direction indicated by arrows 706a and 706b. Therefore the working fluid flow is from interior space 703a, over wings 702a and 702b into interior space 703b then over wings 702c and 702d back into interior space 703a. Wing set 702 is mounted to the interior wall of housing 701 with space to allow the working fluid to flow over it, so that their leading edges are horizontal to the working fluid flow (see, e.g., the leading edge 704a of wing 702a). All wings in wing set 702 are aerodynamic wings and therefore the lift forces created by wing set 702 are substantially vertical as shown in FIG. 7a. Wing set 702 can have wings positioned anywhere within the interior of housing 701, including interior space 703a and 703b. Wing set 702 may have all fixed wings, all adjustable wings or a combination of fixed and adjustable wings.

Thrust engine 700 may be mechanically powered by one or more fluid pumps within housing 701 or heat powered by creating areas with different temperatures within housing 701. As the working fluid flows over each wing in wing set 702, the working fluid has a pressure loss due to the wing's drag force and friction from the interior wall of housing 701. This working fluid pressure loss can cause a decrease in the working fluid velocity and can create an imbalance in the lift forces on the wings in wing set 702. One way to compensate for this working fluid pressure loss is to have more than one fluid pump or to have more than one area with a temperature differential placed apart from one another within housing 701. In one embodiment, thrust engine 700 is mechanically powered by a fluid pump positioned within interior space 703a or 703b. In one embodiment, thrust engine 700 is mechanically powered by two fluid pumps, one fluid pump in interior space 703a and the other fluid pump in interior space 703b. In one embodiment, thrust engine 700 is heat powered, creating a temperature differential between interior space 703a and interior space 703b. According to another embodiment, thrust engine 700 is heat powered, creating a temperature differential between interior space 703a and the interior space occupied by wings 702a and 702b and a temperature differential between interior space 703b and interior space occupied by wings 702c and 702d. In one embodiment, thrust engine 700 is heat powered by adding heating and cooling elements within wing set 702 to create one or more areas with a temperature differential within housing 701.

Another way to compensate for imbalances in wing set 702 lift forces due to fluid pressure loss is to shape housing 701 such that the cross sectional area which working fluid flows through decreases as fluid flows over each wing. Decreasing the cross sectional area can increase the working fluid velocity to compensate for the decrease in working fluid velocity from the working fluid pressure loss. Also adjustable wings within wing set 702 can be controlled to increase the angle of attack to increase lift force for compensating for the imbalances. In one embodiment, thrust engine 700 has a decreasing cross sectional area along the section containing wings 702a and 702b and the section containing wings 702c and 702d. In one embodiment, thrust engine 700 has wing set 702 with one or more adjustable wings that are adjusted by a controller based on the working fluid pressure loss.

When thrust engine 700 is powered by heat, some factors that determine fluid flow direction are the housing 701 shape, the location of areas of relatively high and low working fluid temperature, and control valves within housing 701. A working fluid pressure within a housing can be controlled by changing the cross sectional area to increase (i.e. decrease the cross sectional area) or decrease (i.e. increase the cross sectional area) the working fluid velocity. An area within the housing with the working fluid at a relatively high temperature can create a relatively high working fluid pressure area while an area within the housing with working fluid at a relatively low temperature can create a relatively low working fluid pressure area. Since working fluid flows from a high pressure area to a low pressure area, the housing shape and working fluid temperature differences can be used to force fluid flow in a preferred direction. One-way valves or gates may also be placed within the working fluid path to force fluid in a preferred direction. In one embodiment, thrust engine 700 is powered by heat to create one or more areas with a temperature differential within housing 701 where the working fluid is directed in a preferred direction by shaping housing 701 to have one or more increasing and decreasing cross sectional areas or by locations of areas with relatively high and low temperature working fluid or by both shaping housing 701 and area locations of relatively high and low temperature working fluid.

In another embodiment, thrust engine 750 (FIG. 7b) is modified from thrust engine 700, by orienting wing set 752 vertically. Wing set 752 is mounted to the interior wall of housing 701 with space to allow the working fluid to flow over it such that their leading edges 754a are vertical to the working fluid flow. All wings in wing set 752 are aerodynamic wings and therefore the lift forces created by wing set 702 are substantially horizontal, as shown in FIG. 7b. Wing set 752 may be placed anywhere within interior housing 701, including interior space 703a and 703b. Wing set 752 may be all fixed wings, all adjustable wings or a combination of fixed and adjustable wings.

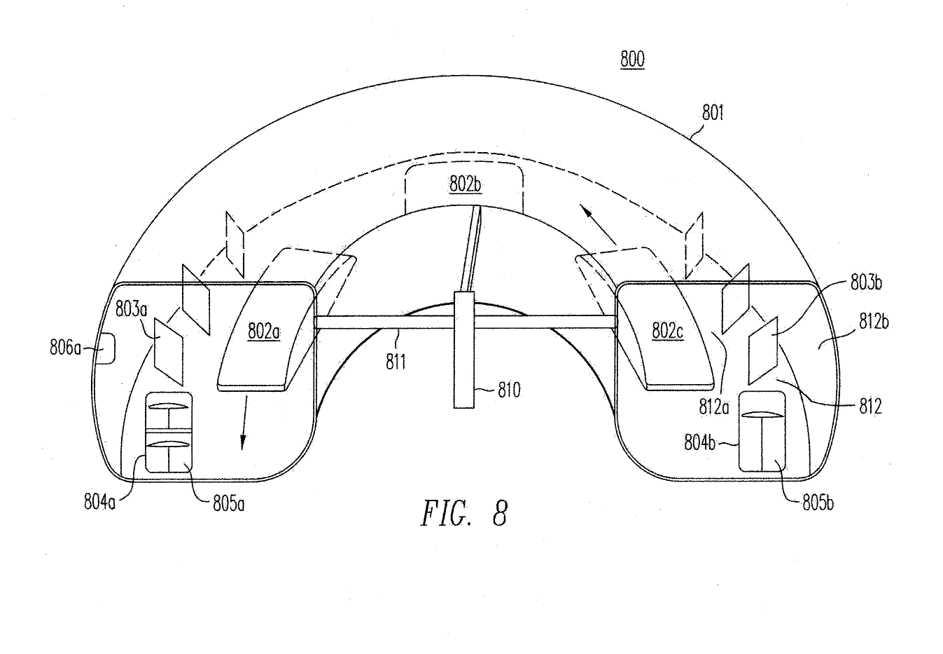

FIG. 8 shows an annular tube 800 with blades rotating through the fluid inside housing 801. In one embodiment, thrust engine 800 includes housing b01 enclosing a working fluid, wing set 802 that includes wings 802a, 802b and 802c connected to axle 810 through support structure 811. Housing 801 has circular space 812 containing working fluid for wing set 802 to rotate in. Fluid director set 803, which includes fluid director 803a and 803b, is attached to a top portion of the wall of housing 801, positioned to create inside space 812a and outside space 812b. Fluid director set 803 are oriented to rotate the working fluid in the opposite direction of wing set 802. Fluid director set 805 is attached to the bottom of interior wall of housing 801 to provide channels for the working fluid to flow through. Wing set 804 is located within the channels formed by fluid director 805 such that there is sufficient space for working fluid to flow between the bottom interior wall of housing 801 and wing set 804. Blade set 806 is attached to housing wall in outside space 812b.

Thrust engine 800 starts up by rotating axle 810 external to housing 801 which rotates wing set 802. All wings of wing set 802 including wings 802a, 802b, and 802c are aerodynamic wings that have their lift force substantially directed upward as it rotates through working fluid. This means wings in wing set 802 have their high pressure side on the bottom surface and low pressure side on the top surface as shown in FIG. 8. Therefore, wing set 802 directs working fluid downward as it rotates within inside space 812a, causing the working fluid to move along the interior wall of housing 801 through the channels formed by fluid director 805, across wing set 804 into outside space 812b and then through fluid director set 803. Wing set 804 creates a lift force in the same direction as wing set 802 from the fluid flowing across it. Once the working fluid flows through fluid director set 803, the working fluid is rotating in the opposite direction of wing set 802. Therefore, the working fluid velocity used to create the lift force on wing set 802 is the relative velocity of the working fluid to wing set 802 (i.e., the sum of the working fluid rotational velocity and wing set 802's rotational velocity). A torque on housing 801 is created as the working fluid flows through fluid director set 803 and a torque in the opposite direction is created as working fluid flows through fluid director set 805. The difference between these torques creates a net torque on housing 801. Blade set 806 may be provided adjustable aerodynamic blades, which are controlled to offset this net torque.

Generally, as discussed above, in the thrust engines of the present invention, a wing with a higher lift-to-drag ratio is deemed more efficient—i.e., the wing creates a greater thrust for a given amount of input power. A wing with a higher lift-to-drag ratio typically has a lower lift coefficient than a wing with a lower lift-to-drag ratio. Other factors also affect the selection of the lift-to-drag ratio (e.g., power dissipation). A rotary ball or rotary cylinder may be provided inside a thrust engine to create a lift force. A rotary thrust engine may be implemented by having aerodynamic blades or other types of blades couple to interior wall of housing of a thrust engine to create torque. A spinning thrust engine can create a thrust force (lift).

Because the working fluid path is continuous, the internal energy and the kinetic energy of the working fluid at the end of each cycle are carried over into the next cycle. In thrust engine 100, the working fluid gains kinetic energy and internal energy from the heat supplied in the hot portion. The working fluid loses internal energy due to heat dissipated in the cold portion and due to kinetic energy loss to drag and frictional forces in wings 101 and 102 and their interior surfaces, as the working fluid moves throughout a cycle. In thrust engine 300, the working fluid gains kinetic energy from fluid structure 107 and loses kinetic energy due to drag and frictional forces in wings 101 and 102 and interior surfaces as the working fluid moves throughout a cycle. In each cycle, when the kinetic energy gained by the working fluid exceeds the kinetic energy loss, the working fluid velocity at the end of the cycle is greater than the working fluid velocity at the beginning of the cycle. Conversely, in each cycle, when the kinetic energy gained by the working fluid is less than the kinetic energy loss, the working fluid velocity at the end of the cycle is less than the working fluid velocity at the beginning of the cycle. The thrust engine reaches equilibrium when the kinetic energy gained equals the kinetic energy loss. In that situation, the working fluid velocity at the beginning of the cycle is equal to the working fluid velocity at the end of the cycle.

In one embodiment, adjustment of blade parameters may be implemented to enable adjustments on the angle of attack, increasing or decreasing the surface area and turning with a range sufficient to maximize L/D ratio or the lift force generated by the wing. Wings that create lift may be tilted, adjusted in referencing the fluid flow direction, fluid velocity and fluid motion to maximize the lift creation. A wing may be adjusted using one, two or three axes. Thrust engine output may be maximized by altering the wing reference area and operating angle of attack.

In one embodiment of present invention, the wings that create lift may be located in anywhere suitable for thrust creation. In another embodiment, the wings that are inside the housing of a thrust engine may form continuous or discontinuous channels for the working fluid to flow. Channels may be enclosed or open. A fluid structure (e.g., fluid structure 107) may be placed in a channel to drive fluid flow to do work on creating lift on wings.

The working fluid flow across high lift-to-drag ratio wings at an optimum angle of attack can maximize the thrust created. The amount of power output to run a thrust engine is related to the fluid angular velocity difference between the outward flow and the inward flow of the fluid structure.

Wings and blades as shown in figures are positioned to best demonstrate the concepts in the present invention. This includes showing wings, aerodynamic blades having zero angle of attack and other blades being straight. Blade geometry and position are dependent on many engine design parameters including the fluid flow path, fluid motion, fluid velocity and angle of attack for wings or blades to create greatest lift to drag ratio as shown.

Wings, blade with airfoil shaped sections and airfoil means objects with aerodynamic effect in this application. Any object with aerodynamic effect may be suitable to implement present invention. A wing is a surface used to produce lift for flight through the air or another gaseous medium. The wing shape is usually an airfoil. A wing may be symmetric where the top and bottom surfaces are equal along the chord line or asymmetric where the top and bottom surfaces are unequal along the chord line. Symmetric wings provide the same lift force at positive and negative angle of attack of equal magnitude while asymmetric wings provide different lift force at positive and negative angle of attack of equal magnitude. Both symmetric wings and asymmetric wings can be used in thrust engines in accordance of the present invention.

In one embodiment, gases are used as the working fluid that circulates inside thrust engines. To maintain a temperature difference for keeping a circulating fluid flow, thrust engines that convert heat energy to thrust operate with heating in one or more areas and cooling in one or more areas.

Other configurations of the thrust engines may have multiple numbers of fluid structures. Within the thrust engine, the lift force generated from each wing is related to the drag force in the wing by the lift-to-drag (L/D) ratio of the wing. The wing's lift force can be greater than the wing's drag force when the L/D ratio of the wing is greater than 1. Wings with L/D ratios greater than 10 are commercially available. The wings within a thrust engine may be designed to provide a desired L/D ratio based on the working fluid velocity and density at the thrust engine equilibrium condition. In one embodiment, the thrust force created by the wings may be greater than the weight of the thrust engine.

Because the thrust force is greater when the temperature difference between upper portion 104a and lower portion 104b is greater, the thrust force may be adjusted by adjusting the temperature between the two portions. Thrust engine 100 harvests the lift force received by a wing which may be located at any location within housing 101 as long as a lift can be generated for the desired output force of housing 101.

The lift force depends on the mass of the fluid flow. Fluid density may be increased by compression, cooling or pressure. Fluid velocity may be increased by pressure, or by limiting fluid volume passing through a specific area. Fluid pressure may be provided by piston, blades, combustion, heat or fluid volume control mechanism. Compression means may be piston, blades or rotary chamber causing angular momentum difference. Piston may have minimum and maximum power conditions.

In some embodiments, heat exchanger may be applied to cool or preheat the fluid or both. The thrust engine of the present invention may be mounted to a vehicle such that the thrust force is directed in a preferred direction to provide vehicle movement. The thrust engine may be mounted directly to the vehicle body or mounted with one axis or two axis of rotation to provide a way to direct the engine thrust in more dimensions. For instance having the thrust engine that has the capability to change the angle of attack of its wings, mounted with one axis of rotation can direct thrust in two dimensions (e.g., forward, reverse, left and right directions) for cars or boats. Vehicles using a thrust engines do not require parts for transmitting rotational power (e.g., the transmission unit, gears and a drive train), because the thrust engine does not produce mechanical output. Consequently, these vehicles are light weight, reliable and low maintenance. Further, because the thrust engine is a completely closed system it is less affected by the environment it operates in. Cars or other land vehicles using the thrust engines of the present invention do not require friction between the ground and tires for acceleration (increasing or decreasing) preventing the vehicle from getting stuck in mud, snow or other hazardous conditions.

According to the present invention, a fluid structure (i.e., a structure having an axle and a set of blades) that sets into motion the working fluid inside a thrust engine may function as an impeller, a propeller, a pump, a compressor, a fan or a blower, depending on the configuration of the set of blade and the applications of the thrust engine. In one embodiment, blades set of a fluid structure may be arranged radial or axially. Blade set of a fluid structure may be placed in peripheral fluid space 104c. A fluid structure suitable for use in thrust engine 300, 500 and 700 may be an axial pump or a radial pump.

Wings, blades with air-foil shape sections and airfoils are objects with aerodynamic effects. Any object providing the requisite aerodynamic effects may be used to implement present invention.

According to the present invention, blade parameters may be adjusted to set a desired angle of attack, surface area and turning with a range sufficient to maximize L/D ratio or lift force generated by the blade. Blades that create thrust may be tilted, adjusted in referencing the fluid flow direction, fluid velocity and fluid motion to maximize the thrust creation. Blades may be adjusted to have horizontal movement, up or down, and turning. The thrust engine's thrust output may be maximized by altering the wing reference area, angle of attack. Adjustable wings that can change the angle of attack can quickly adjust thrust power dynamically. A wing or an aerodynamic blade may comprise one or more airfoils (blades with aerodynamic effects), in accordance with the present invention. Support structures which couple wings to the housing or partition may have adjustable lengths to adjust one or more wings. Support structures which have adjustable lengths can change the angle of attack, orientation or position for one or more wings.

Since wings stay stationary there are no constant moving parts in thrust engines that are powered by heat in accordance of the present invention. Also, a thrust engine powered by heat in accordance to the present invention does not require an axle to drive internal motion.

Working fluid flowing across the blades at an optimum angle of attack and high lift-to-drag ratios can maximize the lift (thrust) created by the blades. The amount of power output to run a thrust engine is the fluid angular velocity difference between the outward flow and the inward flow of the fluid structure.

Blades shown in figures are positioned to best demonstrate the present invention. These figures show aerodynamic blades having zero angle of attack and other blades being straight. Blade geometry and position are dependent on many engine design parameters including the fluid flow path, fluid motion, fluid velocity and blade angle of attack to create greatest lift-to-drag ratio.

The blades creating thrust may be located in anywhere where thrust creation can be achieved. In another embodiment, the blades inside the housing of a thrust engine may form continuous or discontinuous, enclosed or unenclosed channels for working fluid to flow across. A fluid structure for driving fluid flow may be used in each channel.

The detailed description above is provided to illustrate specific embodiments of the present invention and is not intended to be limiting. Numerous modifications and variations within the scope of the invention are possible.

We claim:

1. An engine, comprising:
a housing including an interior space divided into a first portion and a second portion that are connected with each other;
a working fluid filling the interior space which flows, during operation, between the first portion and the second portions; and
one or more airfoils attached to the housing and positioned within the interior space in the circulation path of the fluid flow.

2. An engine as in claim 1 wherein, during operation, a temperature difference is created between the first portion and the second portion, such that the working fluid flows between the first portion and the second portion.

3. An engine as in claim 2, wherein the temperature difference is adjustable to achieve a predetermined fluid flow velocity within the interior space.

4. An engine as in claim 1 wherein, during operation, a propeller drives the working fluid between the first portion and the second portion.

5. An engine as in claim 4, wherein the propeller's rotational speed is adjustable to achieve a predetermined fluid flow velocity within the interior space.

6. An engine as in claim 1, wherein a fluid structure drives the working fluid between the first portion and the second portion.

7. An engine as in claim 5, wherein an amount of fluid pumped by the fluid structure is adjustable to achieve a predetermined fluid flow velocity within the interior space.

8. An engine as in claim 1, wherein the first portion and the second portion is connected by a central portion and a peripheral portion.

9. An engine as in claim 1, wherein the airfoils are positioned to create a lift force in a predetermined direction.

10. An engine as in claim 9, wherein the predetermined direction is determined by an axis of rotation of the housing.

11. An engine as in claim 1, wherein an angle of attack of each airfoil, relative to the working fluid flow, is adjustable.

12. An engine as in claim 11, wherein the angle of attack is adjustable to achieve a predetermined lift-to-drag ratio.

13. An engine as in claim 1, wherein each airfoil has a predetermined lift-to-drag ratio to provide a predetermined lift force.

14. An engine as in claim 13, wherein an angle of attack of each airfoil is adjustable to achieve a predetermined lift-to-drag ratio.

15. An engine as in claim 1, wherein the working fluid comprises a gas.

16. An engine as in claim 15, wherein the gas is pressurized.

17. An engine as in claim 1, further comprising one or more valves provided in walls of the housing for regulating fluid flow between the interior space and the exterior of the housing.
